(19) United States
(12) Patent Application Publication
(10) Pub. No.: US 2009/0014552 A1
(43) Pub. Date: Jan. 15, 2009

(54) Paint spraying apparatus

(76) Inventor: Stephen P. Hines, Glendale, CA (US)

Correspondence Address: JAMES E. BRUNTON, ESQ., P. O. BOX 29000, GLENDALE, CA, 91209, US

(21) Appl. No.: 11/827,840

(22) Filed: Jul. 13, 2007

(51) Int. Cl. B05B 1/28

(52) U.S. Cl. 239/120

(57) ABSTRACT

An exhaust system for capturing overspray from conventional paint spray guns and aerosol paint spray cans that including a vacuum hose that is directly interconnected with the paint spray device being used and is strategically positioned in close proximity to the spray nozzle of the paint spray device. In one form of the invention a conventional household-type vacuum cleaner has the vacuum source.

### BACKGROUND OF THE INVENTION

1. Field of the Invention

The present invention relates generally to paint spraying apparatus. More particularly, the invention concerns a novel paint spray apparatus in which a conventional paint spraying device is interconnected with a vacuum conduit for capturing bounce-back overspray.

2. Discussion of the Prior Art

Paint spraying is widely used in various industries for applying a uniform coating of paint to a work piece. Such a technique is particularly widely used in the automotive industry for painting vehicles. Typically paint spraying is accomplished using a basic spray painting system that consists of a conventional compressed air spray gun, a pressurized paint container, a compressed air system, and conduits connecting these components. Applying the coating material to the work piece is fairly straightforward and conventional, or atomized spray systems typically use air at high pressure (40-70 pounds per square inch) to atomize a liquefied stream of paint. The high-energy air stream finely atomizes the paint, making it relatively easy to apply.

Hand-held compressed air spray guns, which are commonly used for most industrial applications, are readily commercially available and are generally cost-effective, and easy to operate. In the conventional compressed air spray gun, paint is atomized into the droplets of various sizes and transported onto the work piece surface by the pressurized, atomizing air.

Aerosol paint spray cans have also become quite common and are widely used, particularly for small jobs. The typical, readily commercially available aerosol paint spray can comprises a cylindrical-shaped container having a reservoir for containing the paint to be sprayed and the propellant for driving the paint from the container. A finger-operated valve system is mounted in the top of the can and is operated by pressing down on the headpiece of the valve system to commence the flow of paint through the spray nozzle of the device.

Paints of the character typically used in spray painting can contain many hazardous chemicals including organic solvents, toxic metals, and iso-cyanates. Research has shown that higher risks of lung cancer, leukemia, liver cancer, stomach cancer and bladder cancer are related to long-term paint exposure. Accordingly, a major health hazard concern of the spray coating process is ‘overspray’, that is, the small aerosols that do not impact the work piece. If overspray is not contained, it can drift and land on nearby materials or workers. Additionally, bounce-back particles, that is, the small aerosols that bounce off or entirely miss the surface after leaving the spray gun, if not contained, can also drift and land on nearby materials or workers.

Vehicle preparation stations typically have no walls to contain the overspray, and, commonly, a single exhaust fan is relied upon to remove air from the painting area. Studies have shown that the single exhaust fan is quite ineffective in controlling the paint overspray.

Other prior art practices that have been adopted to attempt to solve this serious health hazard, include using respirators and spray booths designed to contain the overspray. However, experience has shown that in the typical workplace the respirators and spray booths are often improperly maintained, and, accordingly, frequently offer little meaningful protection to the worker. Similarly, users of aerosol paint spray cans seldom use respirators or other types of protective devices.

The thrust of the present invention is to address this long-standing health hazard by providing a simple and inexpensive means for effectively capturing overspray. More particularly, the apparatus of the present invention seeks to control hazardous overspray by providing an exhaust system that is directly interconnected with the paint spray device and includes a vacuum tube having an inlet in close proximity to the spray nozzle.

### SUMMARY OF THE INVENTION

It is an object of the present invention to provide a simple, easy-to-use and inexpensive apparatus for effectively capturing overspray during paint spraying operations. More particularly, it is an object of the invention to provide a novel exhaust system for capturing overspray that comprises a vacuum hose that is directly interconnected with the paint spray device and is strategically positioned in close proximity to the spray nozzle of the paint spray device.

Another object of the invention is to provide an overspray capture apparatus of the aforementioned character that uses a conventional household-type vacuum cleaner as the vacuum source.

Another object of the invention is to provide an apparatus as described in the preceding paragraphs which can be used with a conventional paint spray gun and in which the vacuum hose of the conventional household-type vacuum cleaner is directly interconnected with the handle portion of the spray gun.

Another object of the invention is to provide an apparatus of the character described that can be used with a conventional aerosol paint spray can and in which the vacuum hose of the conventional household-type vacuum cleaner is directly connected to a special aerosol can-gripping device that can be interconnected with the top of the aerosol spray and can conveniently be used to operate the valve system.

Still another object of this invention to provide an overspray capture apparatus that is of a simple construction, requires minimum maintenance and is inexpensive to manufacture and install.

### BRIEF DESCRIPTION OF THE DRAWINGS

FIG. 1 is a side-elevational, generally diagrammatic view of one form of the overspray capture apparatus of the present invention illustrating the manner in which the overspray is captured by the vacuum cleaner hose that is interconnected with the paint spray unit.

FIG. 2 is a side-elevational, generally diagrammatic view of an alternate form of the overspray capture apparatus of the present invention for use with aerosol spray cans illustrating the manner in which the overspray is captured by the vacuum cleaner hose that is interconnected with the paint spray can.

FIG. 3 is a front view of the alternate form of the overspray capture apparatus shown in FIG. 2.

FIG. 4 is a generally perspective view of the apparatus of the invention shown in FIG. 2.

### DESCRIPTION OF THE INVENTION

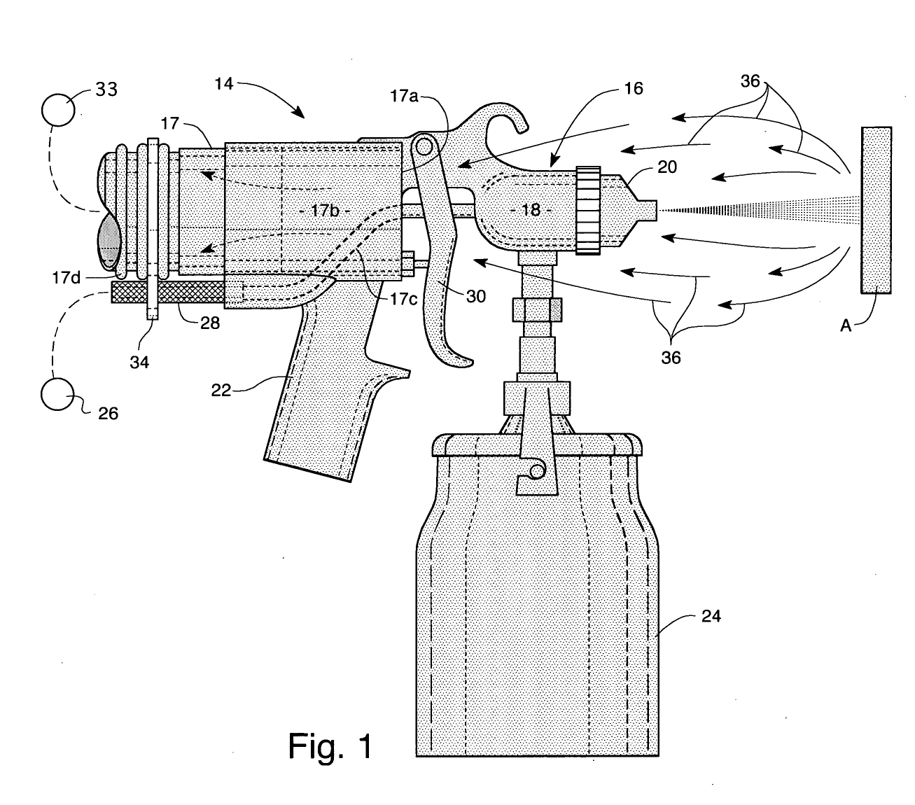

Referring to the drawings and particularly FIG. 1, one form of the overspray and bounce-back capture apparatus of the present invention is there shown in generally designated by the numeral 14. The apparatus here comprises a conventional, readily commercially available type paint spray gun assembly 16 and a vacuum hose 17 that is operably interconnected with the spray gun assembly in the manner shown in FIG. 1. Spray gun assembly 16, which is of conventional construction, comprises a central atomizing chamber 18 having a spray nozzle 20 affixed to one end thereof and a handle portion 22 affixed to the opposite end thereof. In a manner indicated in FIG. 1 of the drawings, a conventional pressurized paint container 24 is operably interconnected with atomizing chamber 18. A source of compressed air 26 is interconnected with atomizing chamber 18 by means of an elongated flexible conduit 28. Interconnected with handle portion 22 is a finger-operated trigger mechanism 30 that controls the flow of air under pressure from the source of compressed air toward the atomizing chamber 18.

Connected to the handle portion 22 of the spray gun assembly is the elongated vacuum hose 17 which is open at one end 17a and is interconnected at its opposite end to a source of vacuum generally designated by the numeral 33. While the vacuum source can take various forms, in the preferred form of the invention the vacuum source is provided in the form of a conventional, household-type vacuum cleaner.

As illustrated in FIG. 1 of the drawings, the outer wall of the connector collar 17b of the vacuum hose 17 houses an “S”-shaped tube 17c to which the air pressure conduit 28 is connected. In the preferred form of the invention the air pressure conduit 28 is securely interconnected to the vacuum hose 17 by a plurality of connector rings, such as connector ring 34, which function to retain the pressure conduit in secure engagement with the outer wall 17d of said vacuum tube.

When the apparatus of the invention is in use to paint an article, such as article “A”, the overspray and bounce-back that occurs during the painting operation, which is depicted by the arrows 36 of FIG. 1, is safely and effectively captured by the vacuum induced by the vacuum source 33 and the strategically positioned vacuum tube 17.

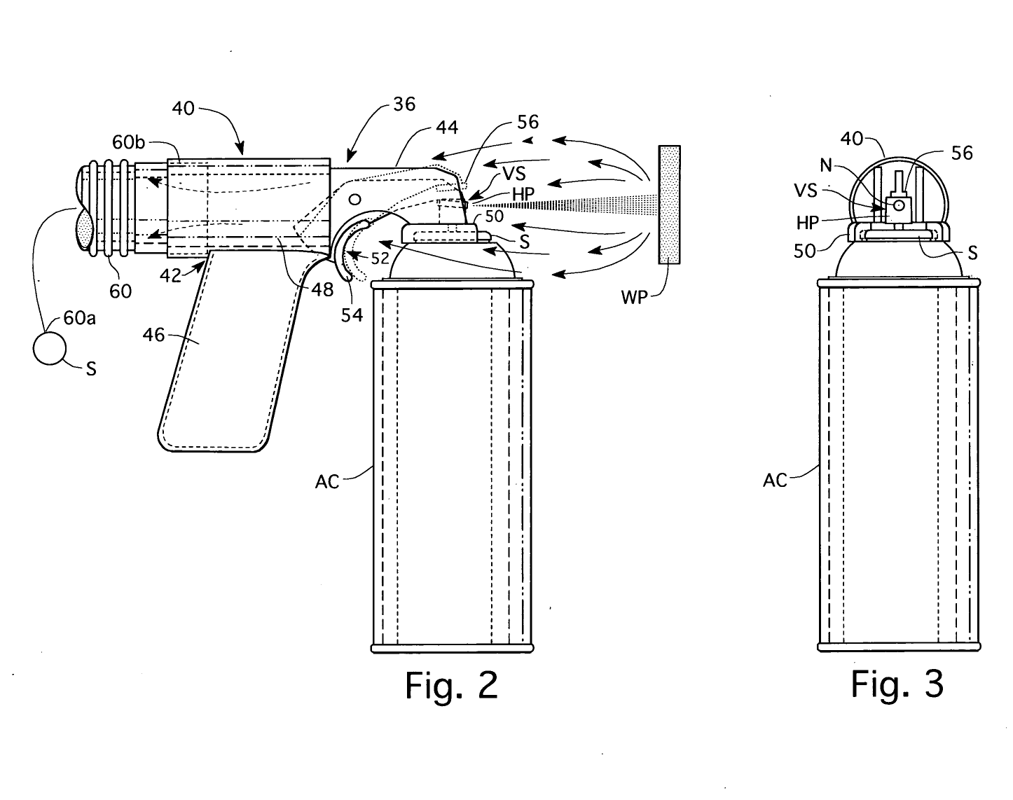

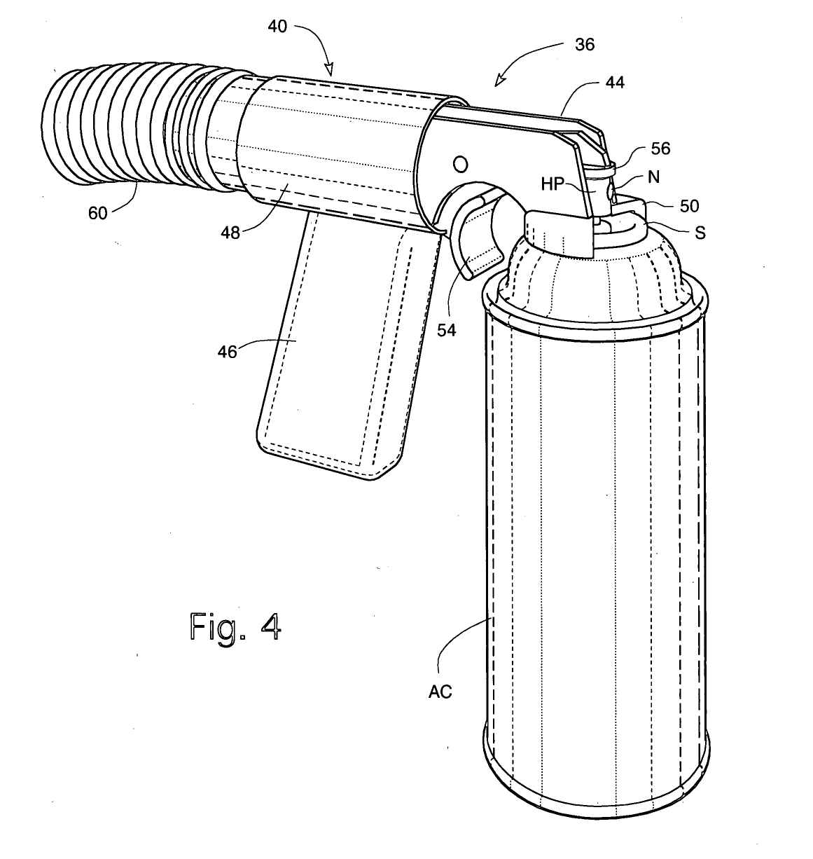

Turning next to FIGS. 2, 3 and 4 of the drawings, an alternate form of the overspray and bounce-back capture apparatus of the present invention is there shown in generally designated by the numeral 36. The apparatus is specially designed for use with readily commercially available aerosol paint spray cans, such as that designated in the drawings as “AC”, which include a cylindrical-shaped container having a reservoir for containing the paint to be sprayed and the propellant for driving the paint from the container. A finger-operated valve system “VS” is mounted in the top of the can proximate an annular shoulder “S” and is operated by pressing down on the headpiece “HP” of the valve system to commence the flow of paint through the spray nozzle “N” of the device (FIG. 3) and toward the work piece “WP”.

As illustrated in FIGS. 2, 3 and 4, this latest form of the invention comprises a can-gripping assembly 40, which includes a handgrip 42 having a forward portion 44, a rearward handle portion 46 and an intermediate body portion 48. Can-gripping assembly 40 also includes connector means connected to forward portion 44 of the handgrip for releasably connecting the can-gripping assembly to the top portion of the aerosol paint can and valve operating means connected to the intermediate body portion 44 of the handgrip for operating the valve member “VS” of the aerosol paint can.

In the present form of the invention the connector means comprises a connector clip 50, which is receivable over the annular shoulder “S” of the can for releasably gripping the shoulder in the manner shown in the drawings.

The important valve operating means of the invention here comprises a trigger mechanism 52 that is pivotally connected to the intermediate body portion 44 of the handgrip. Trigger mechanism 52, which is movable relative to the handgrip between the first position shown by the phantom lines in FIG. 2 and the second position shown by the solid lines, comprises a finger-engaging member 54 and a headpiece-engaging member 56 for depressing the depressible headpiece of the valve system when the trigger mechanism is in the second position.

An important feature of this latest form of the invention is the provision of suction means for capturing the overspray from the spray nozzle “N” of the valve system. As best seen in FIG. 2, this important suction means here comprises an elongated vacuum tube 60 having a first end 60a connected to a vacuum source “S” and a second open end 60b connected to the rearward handle portion 46 of the handgrip.

In using the overspray capture apparatus of this latest embodiment of the invention, the can-gripping assembly is first connected to the top portion of the aerosol paint can in the manner shown in the drawings. Next, the elongated vacuum tube 60 is connected to the can-gripping assembly and the vacuum source, such as a conventional vacuum cleaner, is energized. This done, the finger-engaging member 54 can be pulled rearwardly to the position shown by the solid lines in FIG. 2. This trigger movement causes the paint to be sprayed from the nozzle “N”.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I claim:

1. An overspray capture apparatus comprising a paint spray gun assembly for spray painting a work piece, said spray gun assembly having an atomizing chamber, a spray nozzle affixed to one end of said atomizing chamber, a handle assembly affixed to the other end of the said atomizing chamber, a paint container affixed to and in communication with said atomizing chamber and an air pressure conduit connected to said atomizing chamber for pressurizing the paint container, the improvement comprising an elongated vacuum tube having a first end connected to a vacuum source and a second open end connected to said handle assembly of said paint spray gun assembly proximate said spray nozzle for capturing the overspray from said paint spray gun assembly.

2. The apparatus as defined in claim 1 in which said elongated vacuum tube has an outer wall having an opening therein and in which said air pressure conduit extends through said opening.

3. The apparatus as defined in claim 2 further including a connector ring interconnected with said elongated vacuum tube for connecting said pressure conduit to said elongated vacuum tube and for retaining said pressure conduit in engagement with said outer wall of said vacuum tube.

4. An overspray capture apparatus for use with an aerosol spray can for spray painting a work piece, the aerosol spray can comprising a container having a top portion and a reservoir containing a propellant and the paint to be sprayed, a valve system connected to the top portion and including a valve, a depressible headpiece and a spray nozzle for spraying paint toward a work piece upon operation of the valve, the apparatus comprising:
(a) a can-gripping assembly comprising:
(i) a handgrip having a forward portion, a rearward handle portion and an intermediate body portion;
(ii) connector means connected to said forward portion of said handgrip for releasably connecting said can-gripping assembly to the top portion of the aerosol paint can; and
(iii) valve operating means connected to said intermediate body portion of said handgrip for operating the valve member of the aerosol paint can; and
(b) an elongated vacuum tube having a first end connected to a vacuum source and a second open end connected to said rearward handle portion of said handgrip for capturing the overspray from the spray nozzle of the valve system.

5. The overspray capture apparatus as defined in claim 4 in which the top portion of the container includes an annular shoulder and in which said connector means comprises a connector ring for releasably gripping the annular shoulder.

6. The overspray capture apparatus as defined in claim 4 in which said valve operating means comprises a trigger mechanism pivotally connected to said intermediate body portion of said handgrip for movement relative thereto between a first position and a second position, said trigger mechanism comprising a finger-engaging member and a headpiece-engaging member for depressing the depressible headpiece of the valve system when said trigger mechanism is in said second position.
